(19) United States
(12) Patent Application Publication
(10) Pub. No.: US 2006/0075444 A1
(43) Pub. Date: Apr. 6, 2006

(54) Method and apparatus for content selection

(75) Inventor: Paulus Henricus Antonius Dillen, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/534,809

(22) PCT Filed: Oct. 27, 2003
(86) PCT No.: PCT/IB03/04792

§ 371 Date: May 12, 2005

(30) Foreign Application Priority Data
Nov. 18, 2002 (EP) 02079780.9

(51) Int. Cl. H04N 5/445; H04N 7/173; H04N 5/44; G06F 13/00; G06F 3/00

(52) U.S. Cl. 725/100; 725/38; 348/725; 725/131

(57) ABSTRACT

The invention relates to a system for content selection. A consumer apparatus (101), such as a video recorder, comprises a receiver (103) for receiving content items from a plurality of sources (105, 107, 109, 111). The content items include real-time content items such as TV channels received from broadcast transmitters (105). The content items further include stored content items. The consumer apparatus (101) further comprises a presentation processor (113) which determines an earliest and a latest time of availability for each content item. The available content items are presented in a content set indication, which comprises indications of the earliest and latest times of availability for each content item. A user may select a content item simply by considering the availability times, and need not consider the nature or source of origin of a content item. Hence, an integrated selection list of content items may be provided for content items received from a plurality of various sources.

The invention relates to a method and apparatus for content selection and in particular for content selection of content items from a plurality of various sources.

In recent years, the accessibility to, and provision of, information and content, such as TV programs, film, music and books, etc. have increased explosively. The information and content may today be provided from many different sources, and the variety and availability of content has increased substantially.

For example, the number of available television channels in most countries has increased substantially over the last decade, and in many countries, viewers can receive tens or even hundreds of different TV channels. The TV channels are further provided by different broadcasters and sources, and are communicated through a variety of media including terrestrial radio broadcasts, cable distribution or satellite broadcasts. Similarly, the number of available radio channels has increased explosively and are provided through different media such as satellite broadcasts, digital terrestrial broadcasts, cable distribution or even through the Internet. Furthermore, available content may be provided in real-time format, through, for example, broadcasts, or may be provided on demand from, for example, a storage medium such as a Personal Video Recorder (PVR). Content may also be provided from non-broadcast related storage like CD (CD-DA), Video CD, DVD-Video, etc.

As the available content and content sources have increased substantially, it has become increasingly difficult for a user to find and select the specific content of most interest. Typically, a user selects content items from a list of available content. For example, a PVR has a functionality for displaying a list of recorded programs which the user can select from. Likewise, a television (TV) may display a list of different channels that the user can select by highlighting one option and activating a selection input, for example, in the form of a remote control. Specifically, the channels may comprise a number of content items in the form of TV programs. These may be indicated in an Electronic Program Guide accompanying the TV channels. Similarly, a Compact Disc (CD) or MP3 player may list all the available songs, thereby allowing a specific song to be selected by a user.

However, as the number of available content items and sources has increased, this selection method has become increasingly cumbersome and less attractive as a means of selecting a desired content item. Specifically, the size of the presented lists has increased substantially, and a typical selection list may now comprise tens, hundreds or even thousands of content items. This provides a significant problem to the user as it becomes increasingly difficult to find content items.

Additionally, a selection list is typically provided for each content source. Typically, consumer devices such as Video Cassette Recorders (VCRs), Satellite Receivers, Private Video Recorders, DVD players, etc. are provided as separate units. Each of these units individually generates a list of content items, such as a list of TV channels or programs. However, in order to identify and/or select a content item, the user typically needs to search through a plurality of lists corresponding to the different apparatuses.

Consequently, an improved system for content selection would be advantageous, and in particular a system for facilitating the identification and/or selection of content items received from a plurality of sources.

Accordingly, the invention seeks to mitigate, alleviate-or eliminate one or more of the above-mentioned disadvantages singly or in any combination and/or to provide an improved system for content selection.

According to a first aspect of the invention, an apparatus for content selection comprises: a receiver for receiving content items from a plurality of sources including real-time content sources and content item storage sources; a presentation processor for presenting a content set indication of available content items from said plurality of sources wherein said content set indication comprises a parameter indicating an earliest time of availability of each content item; and a selection processor for selecting a content item from said content set indication of available content.

The inventor of the current invention has realized that a main parameter of interest to a user selecting a content item is the time from which a content is available. Especially, in scenarios where the content items are received from different sources comprising both real-time content sources and content item storage sources, the earliest time of availability typically depends on which source the content item is received from. However, by providing a content set indication comprising a parameter indicating an earliest time of availability, a user is provided with a direct indication of when this content item is available. Specifically, the user may easily determine which content items are available for viewing now, or when a specific content item becomes available regardless of which content source the content item originates from. Hence, the system allows, for example, an integrated content list to be presented for content items from different sources. A user can identify a content item simply from an indication of when the content item is available. Hence, the invention provides the advantage that a user does not need to consider the origin of the source or the distribution method. Rather, the implications of these issues are reflected in the earliest time of availability, and the user therefore only needs to consider the parameter of direct relevance for selection of content items.

The plurality of sources may be internal or external to the apparatus. Specifically, they may include broadcast sources, local content item storage, on-demand sources and any other suitable content source including content playback sources such as CDs and DVDs. The content selection apparatus may thus comprise one or more sources, and specifically a content item storage source may be a local storage medium under the control of the content selection apparatus. The receiver is preferably a multimode receiver capable of simultaneously receiving content items from a plurality of sources of different types and characteristics. Typically, a real-time source provides content items at a time which cannot (or can only to some extent) be controlled by a recipient, for example, because the real-time source distributes the signal to a plurality of recipients (e.g. a TV broadcast source). Typically, a content item storage source is under significant control of a user or content item recipient. For example, the content item storage source may be a local content item memory wherein content items are stored and retrieved at the request of the user of the content selection apparatus. The available content items may specifically be presented as a selection list comprising the content set indication with the earliest time of availability of each content item.

Hence, there may specifically be provided a harmonized and uniform user interface for selection from a plurality of content items with different characteristics and originating from different content sources. The user need not be concerned with the different characteristics or sources but only with the fact when the content item is available.

According to a feature of the invention, the apparatus further comprises a presentation controller for presenting the selected content item to a user. Hence, the selected content item may preferably be presented to the user through a suitable user interface.

According to another feature of the invention, the presentation controller is operable to present a selected content item having a previous earliest time of availability from a beginning of the selected content item. A previous earliest time of availability is a time of availability, which is identical or prior to the current time. Hence, a previous earliest time of availability may be indicated for a content item in a content set indication by an indication of an earliest time of availability of the current time (e.g. indicated as “Now”) or an earlier time. Preferably, any content item that is available now can be presented from the beginning.

According to another feature of the invention, the apparatus further comprises a content item storage for storing content items from the real-time content sources, and wherein the selected content item is from a first of the plurality of real-time content sources and the presentation controller is operable to present the selected content item having a previous earliest time of availability from a beginning of the selected content item by retrieving the selected content item from the content item storage. Preferably, any content item that is available now can be presented from the beginning. This may specifically include a content item from a real-time source which is currently being received (and is thus available now), and for which the already received part of the content item has been stored in a content item storage medium.

According to another feature of the invention, the content set indication comprises no indication of a content source of content items. Preferably, the user may select content items without any consideration of the content source for specific content items, and preferably the content set indication does not comprise an indication of the content source from which the content source has been received. This facilitates the identification and selection for the user and provides a less cluttered content set indication with improved overview.

According to another feature of the invention, the presentation processor is operable to update the parameter indicating an earliest time of availability of each content item in response to a current time. Preferably, the content set indication may be updated in respect to the current time, for example by updating the earliest time of availability of currently available content items to coincide with the current time; or by changing the earliest time of availability to a currently available indication (such as “Available Now”) when the current time reaches the earliest time of availability of a content item.

According to another feature of the invention, the content set indication further comprises a parameter associated with a latest time of availability of each content item. Preferably, the content set indication further provides a latest time of availability, thereby providing the user with an indication of a latest time at which the content item may be selected. For stored content items, the latest time of availability may be a time from which the content item will or may be deleted from the content item storage. Specifically, the latest time of availability may be indefinite or infinite.

According to another feature of the invention, the apparatus further comprises an input processor for receiving a user input associated with the latest time of availability, and for modifying a time of availability of the content item in response to said user input. The time of availability may specifically be the earliest time of availability or the latest time of availability. This may provide the user with a simple and direct method of changing the availability of content items. For example, it may specifically prevent that specific content items are deleted from a content storage until the time of the modified latest time of availability.

According to another feature of the invention, the apparatus comprises a recording controller for instigating a recording of a content item in response to modifying the latest time of availability. For example, a real-time content item may only be available at a specific time. If the user prefers to extend the time of availability, this may be achieved simply by adjusting the latest time of availability, thereby causing the real-time content item to be recorded for later retrieval. Hence, the user need not be concerned with the source or nature of the content item, but can simply change the time of availability of any content item, and the apparatus may consequently automatically cause a recording to be made when necessary.

According to another feature of the invention, a stored content item is removed from the content item storage at the time of the latest time of availability for the stored content item. Preferably, content items are deleted from content item storage at the latest time of availability, thereby making space for other content items to be stored.

According to another feature of the invention, the content items of the content set indication are arranged in response to the latest time of availability. Preferably, the content items comprised in the content set indication are presented in an ordered way. For example, the content set indication may be a list comprising content items arranged in order of the latest time of availability. Arranging content items in response to the latest time of availability allows a user to easily identify content items having a suitable latest time of availability.

According to another feature of the invention, the content set indication comprises a parameter associated with a cost of at least some of the content items. This allows the user to easily determine a cost associated with a content item. The cost may furthermore be dependent on the earliest and/or latest time of availability. For example, the same content may be available in two or more content items having different earliest and/or latest times of availability, and the cost may be different depending on these times. Including the cost indication assists the user in selecting between these options.

The cost of a content item may be determined in response to a time of availability. This may be, for example, the earliest or latest time of availability. The cost may be dynamically updated in response to changes in a time of availability. For example, a user may extend the time of availability by modifying the latest time of availability. This may cause the content item to require storage or longer storage or to be distributed at a more inconvenient time. This may result in a cost impact to the user, which may readily be indicated to the user. Preferably, a user may thus be presented with a cost indication of a content item, and this cost indication may dynamically be updated in response to modifications to a time of availability. A user can thus directly determine a cost impact of, for example, time shifting a desired content item.

According to another feature of the invention, the content set indication comprises a parameter associated with a quality of at least some of the content items. Different content items may relate to the same content but with different qualities. An indication of e.g. presentation quality allows the user to directly identify and select content items of a desired presentation quality. The quality may be associated with a cost identification allowing the user to select a quality that meets both quality and cost considerations.

According to another feature of the invention, the content items of the content set indication are arranged in response to the earliest time of availability. Preferably, the content items comprised in the content set indication are presented in an ordered way. For example, the content set indication may be a list comprising content items arranged in order of the earliest time of availability. Arranging content items in response to the earliest time of availability allows a user to easily identify content items having a suitable earliest time of availability.

According to another feature of the invention, the content items of the content set indication are arranged in response to at least one parameter chosen from the group of: a title of the content item; an artist of a content item; and a category of the content item. Preferably, the content items comprised in the content set indication are presented in an ordered way. For example, the content set indication may be a list comprising content items arranged in order of a content parameter suited for facilitating the localization of desirable content items. Specifically, the parameters of a title of the content item; an artist of a content item; and/or a category of the content item are suitable for facilitating identification of content items in a content set indication.

According to another feature of the invention, the apparatus as defined in claim 1 further comprises: an input processor for receiving a user input and for modifying a time of availability of the content item to a modified time of availability in response to said user input; and a communication element for communicating the modified time of availability to at least one of the plurality of sources. Hence, the modification of a time of availability may be communicated to, for example, an external source, thereby allowing this source to adjust the provision of content items to suit the user.

According to another feature of the invention, the apparatus further comprises means for modifying a cost of the content item in response to the modified time of availability. This allows the user to be easily informed of any cost impact of modifying the time of availability.

According to another feature of the invention, the content set indication comprises an independent indication of whether a content item is currently available. This indication may be a simple binary indication such as, for example, a simple ‘available now’ yes/no indication. This provides a simple and user-friendly indication of what content items are currently available.

According to a second aspect of the invention, a method of content selection comprises the steps of: receiving content items from a plurality of sources including real-time content sources and content item storage sources; presenting a content set indication of available content items from said plurality of sources, wherein said content set indication comprises a parameter indicating an earliest time of availability of each content item; and selecting a content item from said content set indication of available content.

These and other aspects of the invention are apparent from and will be elucidated with reference to the embodiment(s) described hereinafter.

An embodiment of the invention will be described, by way of example only, with reference to the drawings, in which

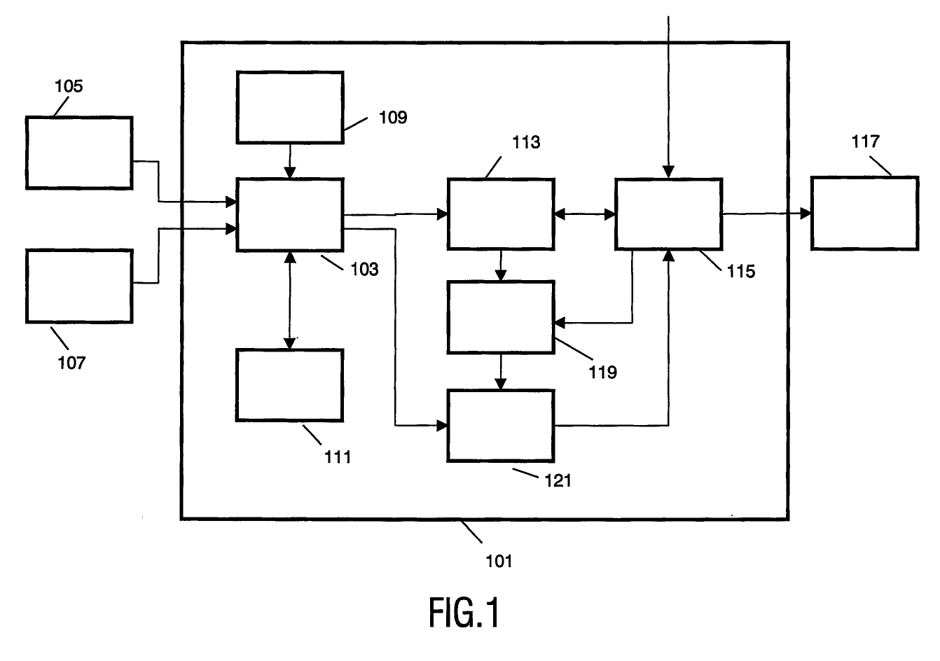

FIG. 1 is an illustration of an apparatus for content selection in accordance with an embodiment of the invention; and

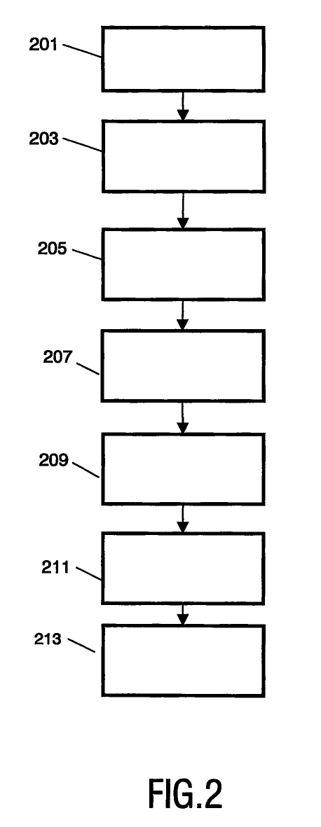

FIG. 2 is an illustration of a method of content selection in accordance with a preferred embodiment of the invention.

The following description focuses on an embodiment for a video or audio consumer device, such as a Private Video Recorder (PVR), but it will be apparent that the invention is not limited to this application.

Specifically, the description will focus on an embodiment comprising a multi-function PVR comprising a functionality for receiving content items from both internal and external sources.

FIG. 1 is an illustration of an apparatus for content selection in accordance with an embodiment of the invention. Specifically, the apparatus is a PVR 101 comprising a content receiver 103. The content receiver 103 receives content items from one or more suitable content item sources. In the described embodiment, the content receiver 103 receives content from external sources in the form of a radio TV broadcast source 105 and an on-demand TV source 107 distributing on-demand content through a direct cable connection. Especially, the TV broadcast source 105 provides real-time content in the form of TV channels comprising scheduled TV programs.

Furthermore, the content receiver 103 receives content from internal sources in the form of an integrated DVD player 109 and an internal content item storage 111. Specifically, the content item storage is a hard disk suitable for storing digitally encoded audio and video signals, e.g. in accordance with the MPEG 2 encoding scheme.

Thus, in the preferred embodiment, the content receiver 103 is capable of receiving content from a plurality of various content sources. The content receiver 103 may receive content items in the form of both video, audio and multimedia clips and programs. The content receiver 103 may simply be implemented as the combination of a plurality of independent content receiver elements, where each element is dedicated to receiving content items of a specific nature from a specific source.

Some of the received content items from the external sources 105, 107 may be stored in the content item storage 111 under the control of a recording controller (not shown), which may be part of the content receiver 103. In this case, the received content items are converted to suitable digital formats and stored in the content item storage 111 together with information associated with the content items. Specifically, a content item may be received directly in a suitable format, such as an MPEG 2 format, and in this case no conversion is required.

The PVR 101 further comprises a presentation processor 113 coupled to the content receiver 103. The presentation processor 113 is operable to determine a parameter indicating an earliest time of availability for each of a plurality of content items received or to be received by the content receiver 103. The presentation processor 113 is furthermore operable to determine a parameter indicating a latest time of availability for each of a plurality of the content items received or to be received by the content receiver 103.

Thus, for each of a plurality of content items received or to be received by the content receiver, the presentation processor 113 determines the first and last time at which the content item is available for selection. The plurality of content items may be all available content items or a subset thereof.

Specifically, for a real-time TV program received from the TV broadcast source 105, the earliest time of availability may be the start time of the program broadcast time. The latest time of availability may be the end time of the program broadcast time, or in some embodiments may be the start time of the program broadcast time. Thus, in some embodiments, real-time content items will have identical earliest and latest times of availability, reflecting that the program can be viewed in its entirety only at that time.

The earliest time of a content item available from the on-demand TV source may be a first time from which the content item can be requested, and the latest time of availability may be the last time at which a program can be requested.

For stored content items, the earliest time of availability may be the current time, and the latest time of availability may be a time at which the content item is scheduled to be deleted.

As a specific example, a content item from the TV broadcast source 105 may be scheduled to be recorded and stored in the content item storage 111. In this case, the earliest time of availability may be the time at which the content item is broadcast, and the latest time of availability may be the time at which the content item is set to be deleted from the content item storage 111. Specifically, the latest time of availability may be indefinite or infinite reflecting that no deletion of the content item is scheduled or planned.

The broadcast and request times for the content items of the external sources 105, 107 may be determined in any suitable way and by any suitable means. Preferably the external sources communicate data comprising scheduling information to the PVR 101, and the details for a specific content item may be extracted therefrom. Specifically, the TV broadcast source 105 may broadcast an Electronic Program Guide (EPG), and the PVR 101 may determine the broadcast start and end times from this.

The content items available from the DVD player 109 may be the contents of the DVD disc currently in the DVD player. The earliest time of availability of this content may be the current time, and the latest time of availability may be indefinite or infinite. In some embodiments, the content items of the DVD player comprise the content items of a group of DVDs, for example, corresponding to a selection of DVDs owned by a user. The earliest time of availability of the disc currently in the DVD player may be the current time, whereas the earliest time of availability of other discs of the group may reflect that a disc change is required (for example, the earliest time of availability may be set to “soon” “Disc Change”).

In response to the determined availability times, the presentation processor 113 is capable of determining a content set indication of available content items. In the preferred embodiment, the content set indication comprises a list of content items with an indication for each content item of an earliest time of availability and a latest time of availability.

As a specific example, a given content set indication may be as follows:

| | | Content Item | |
|---|---|---|---|
| Available from | Available until | Description | Source |
| Now | Infinite | Content Item 1 | DVD-V |
| Now | Thursday 10 pm | Content Item 2 | Internal |
| | | | Storage |
| Tuesday 8 pm | Tuesday 9 pm | Content Item 3 | TV Broadcast |
| | | | Source |
| Wednesday | Friday 7 pm | Content Item 4 | TV Broadcast |
| 7 pm | | | Source/ |
| | | | Internal |
| | | | Storage |
| Friday 9 pm | Infinite | Content Item 5 | TV Broadcast |
| | | | Source/ |
| | | | Internal |
| | | | Storage |
| Saturday 1 pm | Sunday 1 pm | Content Item 6 | On-demand |
| | | | source |

Hence, the content set indication shows that content item 1 is available from now from the DVD player without any limitation as to the end of the availability. Content item 2 has been recorded onto the content item storage item and is available from now but will be deleted on Thursday 10pm. Content Item 3 will be broadcast on Tuesday 8pm and will finish at 9pm. It will not be recorded and is only available at this time. Content Item 4 will be broadcast on Wednesday 7pm and will be recorded and kept in the internal content item storage until Friday 7pm. In this case, the content source indication may change over time, such that the indication first indicates that it is from the TV Broadcast source (e.g. “live”) and, after transmission, it is from the internal storage (e.g. “recorded). Content item 5 will be broadcast on Friday 9 pm. It will be recorded and will not be deleted (unless manually deleted by the user). Content item 6 can be requested from the on-demand TV source 107 from Saturday 1pm until Sunday 1pm.

In some embodiments, the content set indication may further comprise an independent indication of whether a content item is currently available. Specifically, the content set indication may comprise a further sub-column headed “Available Now” having a “Yes” or “No” entry for each content item depending on whether the content item is currently available.

The presentation processor 113 is coupled to a user interface 115. The user interface 115 is further coupled to a presentation device 117 such as a TV or video monitor. The presentation processor 113 is operable to feed the content set indication to the user interface 115, which is then capable of displaying it on the presentation device 117.

The user interface 115 is further capable of receiving a user input. In the preferred embodiment, the user input is received by using a remote control communicating with the user interface 115. In the preferred embodiment, the user interface is thus operable to display various information to the user and to receive user inputs. Specifically, the user interface may display the content set indication and receive a user selection input in response. In particular, the user may select a given content item by highlighting the content item in the content set indication.

The user interface 115 is coupled to a selection processor 119, which is operable to select a content item from the content set indication. Specifically, the user selection input is correlated with the content set indication generated by the presentation processor 113 in order to identify a specific content item.

In the preferred embodiment, the selection processor 119 is coupled to a presentation controller 121. The presentation controller is further coupled to the content receiver 103 and the user interface 115. In response to a user selection received from the selection processor 119, the presentation controller 121 controls the content receiver to provide the selected content item, which is then fed to the user interface 115 for presentation on the presentation device 117.

FIG. 2 is an illustration of a method of content selection in accordance with a preferred embodiment of the invention. The method will hereinafter be described with reference to the PVR 101 of FIG. 1.

In step 201, the content receiver 103 receives a plurality of content items from content sources (105, 107, 109, content item storage 111). The content items include real-time content items from content item sources as well as non-real-time content items from content item storage sources. In addition, the content receiver 103 receives information related to future content items from e.g. real-time content item sources.

The method continues in step 203 wherein the presentation processor 113 determines an earliest time of availability for each content item. The method then proceeds in step 205 wherein the presentation processor 113 determines a latest time of availability for each content item.

Step 205 is followed by step 207 wherein the presentation processor 113 generates a content set indication which comprises a parameter related to the earliest time of availability for each content item and preferably the latest time of availability of each content item.

In the preferred embodiment, the content set indication is arranged in a suitable order. Specifically, the order may be changed in accordance with a user preference, which may be determined by a direct user input e.g. from the user activating a button on the remote control.

Specifically, the content set indication may be ordered in response to the latest time of availability or to the earliest time of availability. In the preferred embodiment, the content set indication is thus a content item list arranged in an increasing or decreasing order of the earliest time of availability or the latest time of availability. This enable the user to quickly localize content items having a suitable availability.

Alternatively or additionally, the content set indication may be arranged in response to content parameter for each content item. The content parameter is preferably chosen from the group of: a title of the content item; an artist of a content item; and a category of the content item. Hence, a content item list may be presented which includes an alphabetic ordering of the title of the content items, the name of an artist associated with the content item or of a category of the content item. This allows a given content item to be easily localized, whereafter the availability can be determined for the content item.

The method continues in step 209 by the content set indication being fed to the user interface 115 from the presentation processor 113 for presentation to the user on the presentation device 117.

In step 211, which follows step 209, a user input is received from the user through the user interface 115. Step 211 is followed by step 213 where a content item is selected in response to the user input. The selected content item is presented to the user through the user interface 115.

In the preferred embodiment, the presented content set indication of the earliest time of availability is updated to reflect the current time. For example, all content items having an earliest time of availability before the current time are simply indicated as being available, regardless of the moment of their earliest time of availability.

In the preferred embodiment, a content item which has an earliest time of availability earlier than the current time may be presented from the start of the content item regardless of whether the content item is a real-time content item or a stored content item. Specifically, a content item received from a real-time source, such as the broadcast TV source 105, is automatically stored in the content item storage from the beginning of the content item. If the content item is requested during the broadcast, the presentation controller 121 will not feed the signal currently being received from the broadcast TV source 105 to the user interface 115. Rather, the selected content item is presented by retrieving the beginning of the content item from the content item storage.

Furthermore, the preferred embodiment comprises a functionality for the user to modify the parameters of the content set indication and specifically to modify the earliest time of availability or the latest time of availability of one or more content items.

Specifically, the latest time of availability of a content item may be adjusted in response to a user input received through the user interface. For stored content items, this will preferably have the effect of changing the time at which the content item is deleted. The parameters of the PVR 101 and external sources 105, 107 may be modified to reflect the changed availability times. Hence, the user need not be concerned with the required operation of any of the involved entities, but rather may simply adjust the availability requirements, and the system will consequently perform the required functionality required to achieve this availability.

Thus, in one embodiment, a recording may be instigated in response to a latest time of availability being modified. Hence, if the latest time of availability is extended for a real-time content item, this can be achieved by recording the content item onto the content item storage 105 for later retrieval. The content item can then be retrieved from the content item storage 105 whenever necessary. Hence, the availability of the content item is modified according to the user's preference without the user needing to consider whether any recording is required or indeed the nature or source of origin of the content item.

In the preferred embodiment, the PVR 101 further comprises a communication element for communicating the modified time of availability to one or more of the sources. Hence, if a content item from the on-demand TV source 107 is requested to be available at a specific time, this information may be communicated to the on-demand TV source 107, which may then arrange for the content item to be available at this time.

When the current time exceeds the latest time of availability of a stored content item, this is deleted from the content item storage 105.

In some embodiments, the content set indication may further comprise a cost indication. This may facilitate the user in selecting content items, specifically if the cost depends on the time of availability. For example, the same content item may be provided at a first time at a first cost and at a second time at a lower cost. In this case, the user may readily choose between selecting the content item at the first time, or reducing the associated cost by waiting for the second time.

Furthermore, the content set indication may comprise a parameter associated with a presentation quality of at least some of the content items. This quality indication may be associated with a cost indication. For example, a given content may be provided by a first content item with a high video and audio presentation quality at a high cost at a first time or by a second content item with a lower video and audio presentation quality and associated cost at a second time. In this case, the user may readily choose between the first and second content items taking into account the availability of the different content items. The time of availability may of course be identical, similar or overlapping.

In some embodiments, the cost of a content item will be dependent on the time of availability of a content item. For example, in many on-demand TV systems, the capacity of the communication lines is a limiting factor. This is especially the case for narrowcast or point-to-point services. These communication lines may be shared between many users, and therefore the capacity may be insufficient at peak times. Consequently, the on-demand content provider is interested in shifting some demands towards the off-peak period by providing a lower cost per content item. Accordingly, if a user modifies the availability time of an on-demand content item to be comprised in an off-peak time period, the cost of the content item may be reduced compared to when it includes the peak period. In some embodiments, a cost indication for each content item may therefore be updated in response to the time of availability being changed by a user.

As another example, in multicast oriented on-demand systems, distribution costs may be higher for distribution of a content item outside a scheduled period as the distribution cost cannot be shared among a large number of users. In this case, the content item may be provided during a non-scheduled period in return for an increased charge.

In the preferred embodiment, the content set indication comprises an indication of the content source associated with each content item. However, in other embodiments, the content set indication may not comprise any parameter indicating the content source. Hence, from manipulation of the availability times, the user may simply control the operation of the apparatus, and alternatively or additionally the content sources to store, request and present the content items as required.

It is within the contemplation of the invention that the content items may comprise content items of any suitable type or category. Specifically, the content items may comprise a combination of one or more of the categories of a video source content item such as a video clip or TV program, an audio source content item such as an audio clip or a radio program or a multimedia source content item such as a multimedia clip.

The invention can be implemented-in any suitable form including hardware, software, firmware or any combination of these. However, the invention is preferably implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the use of the verb “comprise” and its conjugations does not exclude the presence of other elements or steps. Furthermore, although individually stated, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second”, etc. do not preclude a plurality.

1. An apparatus (101) for content selection, comprising
a receiver (103) for receiving content items from a plurality of sources (105, 107, 109, 111) including real-time content sources and content item storage sources;
a presentation processor (113)for presenting a content set indication of available content items from said plurality of sources (105, 107, 109, 111) wherein said content set indication comprises a parameter indicating an earliest time of availability of each content item; and
a selection processor (119) for selecting a content item from said content set indication of available content.

2. An apparatus as claimed in claim 1, further comprising a presentation controller (121) for presenting the selected content item to a user.

3. An apparatus as claimed in claim 2, wherein the presentation controller (119) is operable to present a selected content item having a previous earliest time of availability from a beginning of the selected content item.

4. An apparatus as claimed in claim 3, comprising a content item storage (111) for storing content items from the real-time content sources, and wherein the selected content item is from a first of the plurality of real-time content sources and the presentation controller (121) is operable to present the selected content item having a previous earliest time of availability from a beginning of the selected content item by retrieving the selected content item from the content item storage (111).

5. An apparatus as claimed in claim 1, wherein the content set indication comprises no indication of a content source of content items.

6. An apparatus as claimed in claim 1, wherein the presentation processor (113) is operable to update the parameter indicating an earliest time of availability of each content item in response to a current time.

7. An apparatus as claimed in claim 1, wherein the content set indication further comprises a parameter associated with a latest time of availability of each content item.

8. An apparatus as claimed in claim 7, further comprising an input processor (115) for receiving a user input associated with the latest time of availability and for modifying a time of availability of the content item in response to said user input.

9. An apparatus as claimed in claim 8, comprising a recording controller for instigating a recording of a content item in response to modifying the latest time of availability.

10. An apparatus as claimed in claim 7, wherein a stored content item is removed from the content item storage at the time of the latest time of availability for the stored content item.

11. An apparatus as claimed in claim 7, wherein the content items of the content set indication are arranged in response to the latest time of availability.

12. An apparatus as claimed in claim 1, wherein the content set indication comprises a parameter associated with a cost of at least some of the content items.

13. An apparatus as claimed in claim 1, wherein the content set indication comprises a parameter associated with a quality of at least some of the content items.

14. An apparatus as claimed in claim 1, wherein the content items of the content set indication are arranged in response to the earliest time of availability.

15. An apparatus as claimed in claim 1, wherein the content items of the content set indication are arranged in response to at least one parameter chosen from the group of:
a title of the content item;
an artist of a content item; and
a category of the content item

16. An apparatus as claimed in claim 1, further comprising:
an input processor (115) for receiving a user input and for modifying a time of availability of the content item to a modified time of availability in response to said user input; and
a communication element for communicating the modified time of availability to at least one of the plurality of sources.

17. An apparatus as claimed in claim 16, further comprising means for modifying a cost of the content item in response to the modified time of availability.

18. An apparatus as claimed in claim 1, wherein the content set indication comprises an independent indication of whether a content item is currently available.

19. A method of content selection, comprising the steps of:
receiving (201) content items from a plurality of sources including real-time content sources and content item storage sources;
presenting (209) a content set indication of available content items from said plurality of sources, wherein said content set indication comprises a parameter indicating an earliest time of availability of each content item; and
selecting a content item from said content set indication of available content.

20. A method as claimed in claim 19, further comprising the steps of:
receiving a user input;
modifying a time of availability of the content item to a modified time of availability in response to said user input;
communicating the modified time of availability to a first of the plurality of sources;
receiving the content item from the first of the plurality of sources at a time corresponding to the modified time of availability.

21. A computer program enabling a method to be carried out according to claim 19.

22. A record carrier comprising a computer program as claimed in claim 21.
